(19) United States
(12) Patent Application Publication
(10) Pub. No.: US 2008/0315145 A1
(43) Pub. Date: Dec. 25, 2008

(54) FLUID CONTROL VALVE DEVICE

(75) Inventor: Yoshinori KAWAMURA, Obu-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 12/132,242

(22) Filed: Jun. 3, 2008

(30) Foreign Application Priority Data
Jun. 19, 2007 (JP) 2007-161395

(51) Int. Cl. F16K 1/32; F16K 27/02

(52) U.S. Cl. 251/318; 251/368; 251/366

(57) ABSTRACT

One aspect of the present invention includes a fluid control valve device having a valve portion and a bearing portion. The valve portion is constructed with a valve seat arranged within a valve housing and a valve body, which moves towards and away from the valve seat in an axial direction. The bearing portion is configured to accommodate a bearing and a seal. The bearing supports a valve shaft that extends together with the valve body. The seal is attached around a valve shaft in order to prevent fluid from entering the bearing portion. A surface of the valve shaft, at least a portion that slidably contacts the seal, may have a hydrophobic property. Peripheral grooves may be formed in an inner circumferential surface of the valve housing at a position proximal to the valve portion on an upstream side and/or a downstream side. The grooves open toward a side opposing to the valve seat in a flow direction.

This application claims priority to Japanese patent application serial number 2007-161395, the contents of which are incorporated herein by reference.

### BACKGROUND OF THE INVENTION

1. Field of the Invention

The present invention relates to a fluid control valve device for controlling a fluid flow rate.

2. Description of the Related Art

Recently, a fuel cell powered vehicle that may offer a solution for air pollution caused by exhaust emissions of automobiles was proposed. The fuel cell generates electric power by an electric chemical reaction of hydrogen and oxygen, which is a reverse reaction to electrolysis. The only emission this fuel cell has is water, and thus is used as a clean power source. In general, a solid polyelectrolyte membrane type fuel cell that utilizes a polymer ion exchange membrane as electrolyte is mostly used for automobiles. This is because the solid polyelectrolyte membrane type fuel cell allows a high output density and has a simple construction, so that it is possible to reduce space. Further, another advantage of the solid polyelectrolyte membrane type fuel cell is that it can be operated at relatively low temperature, e.g., about 70-90° C.

The fuel cell mechanism is provided with a cell stack, in which a plurality of cells are stacked. An electrolyte is interposed between an anode and a cathode to form each cell. The fuel cell mechanism is further provided with a fuel gas (hydrogen) supply channel communicated with an anode side, an oxidant gas (air) supply channel communicated with a cathode side and a discharge channel for discharging unreacted gas that has passed through the cell stack and/or water produced by an electrochemical reaction. The hydrogen to be delivered from the fuel gas supply channel is supplied from a hydrogen cylinder or delivered to the cell stack as a reformed gas via a reformer. Air to be supplied from the oxidant gas supply channel is external air compressed by an air compressor. In this configuration, it is necessary to properly control each gas flow rate (gas pressure) so that reaction in the fuel cells is efficient. If the flow rates of hydrogen gas and the air are varied and therefore, the difference in pressure between the hydrogen gas and the air is produced, it may cause an early deterioration or a damage of the solid polyelectrolyte membrane. In order to avoid these problems, it is known to arrange a fluid control valve to a part of a fuel gas supply channel, an oxidant gas supply channel or a discharge channel for controlling each gas flow rate. For example, when the hydrogen gas supply rate is reduced, the air supply rate must be controlled. In this case, a fluid control valve may be provided to a bypass pipe that communicates the oxidant gas supply channel and the discharge channel. The air supply rate to the stack can be controlled by opening and closing the fluid control valve, which is provided to the bypass pipe.

A fluid control valve is integrated to a fluid control valve device. The fluid control valve device basically has a valve portion and a bearing portion. The valve portion is constructed with a valve seat arranged within a valve housing and a valve body, which reciprocally moves towards and/or away from the valve seat in an axial direction. The bearing portion accommodates a bearing for supporting a valve shaft coupled to the valve body. Because the air contains water, such as water vapor, if this fluid control valve device is used for controlling an air flow rate, in winter or in a cold region, the valve body may be adhered to the valve seat or the valve shaft may be adhered to the bearing due to the frozen fluid caused when the condensed water in the air is deposited on the valve body and the valve shaft. In this case, the valve must be opened or closed against the adhesion force of frozen fluid (ice), therefore, it may lead to an operational failure.

A known fluid control valve device for an exhaust gas recirculation for a gasoline-fueled automobile is disclosed, for example in Japanese Laid-Open Patent Publication No. 2000-39082 and Japanese Laid-Open Patent Publication No. 58-74970. The known fluid control valve device is further disclosed in Japanese Laid-Open Patent Publication No. 2002-349360. Fluid control valve devices according to Laid-Open Patent Publication No. 2000-39082 and Japanese Laid-Open Patent Publication No. 2002-349360 incorporate a construction to prevent water from entering a bearing portion. A fluid control valve device according to Laid-Open Patent Publication No. 58-74970 attempts to prevent a valve portion from freezing. More particularly, a holder cover is provided to a front portion of a bearing portion according to Japanese Laid-Open Patent Publication No. 2000-39082 in order to prevent water from entering the bearing portion. A front portion of a valve portion according to Japanese Laid-Open Patent Publication No. 2002-349360 protrudes into a flow channel within a valve channel. A hydrophobic material may be used for a part of a valve body surface, in which the valve body may contact a valve seat according to Laid-Open Patent Publication No. 58-74970.

Fluid control valve devices according to Japanese Laid-Open Patent Publication No. 2000-39082 and Japanese Laid-Open Patent Publication No. 2002-349360 have a holder cover for preventing water from entering a bearing portion. Further, the bearing portion is configured to protrude into a flow channel. However, these constructions may not completely prevent water from entering the bearing portion. Therefore, it may still lead to an operational failure of the valve. Accordingly, if a resilient seal member is attached to the bearing portion, the entrance of water may be effectively prevented. However, if the water (fluid) deposited on contact portions between the seal and the valve shaft is frozen, the seal must be removed from the valve shaft against the adhesion force of ice when the valve is opened or closed. Consequently, if the seal is repeatedly frozen and removed, the seal may be damaged. Japanese Laid-Open Patent Publication No. 58-74970 discloses a fluid control valve device having a valve body of which surface is coated with a hydrophobic material so that fluid may hardly deposit on the surface of the valve body. However, if condensed water trickles down along the inner surface of the valve housing is added to water already deposited on the contact portions, excessive water is deposited on contact portions of the valve seat body and valve seat, also due to the surface tension at the contact portions, it is not guaranteed that the contact portions reliably repel water.

It is therefore an object of the present invention to provide a fluid control valve device that can reliably reduce a water deposit on contacting portions with a valve in order to prevent an operational failure or a damage when the fluid control valve device is actuated under a low temperature, in which the water may be frozen.

### SUMMARY OF THE INVENTION

One aspect according to the present invention includes a fluid control valve device that has a valve portion and a bearing portion. The valve portion is constructed with a valve seat arranged within a valve housing and a valve body, which reciprocally moves towards and/or away from the valve seat in an axial direction. The bearing portion is provided for accommodating a bearing and a seal. The bearing supports a valve shaft that extends in conjunction with the valve body. The seal is attached around a valve shaft in order to prevent fluid from entering the bearing portion. A surface of the valve shaft, at least a portion that slidably contacts the seal, is coated with a hydrophobic material.

In one embodiment, preferably, fluorine resin may be used for coating a surface of the valve shaft in order to impart a hydrophobic property.

In another embodiment, the fluid control valve device has a valve portion and a bearing portion. The valve portion is constructed with a valve seat arranged within a valve housing and a valve body, which reciprocally moves towards and/or away from the valve seat in an axial direction. The bearing portion is provided for accommodating a bearing and a seal. The bearing supports a valve shaft that extends in conjunction with the valve body. The seal is attached around a valve shaft in order to prevent fluid from entering the bearing portion. Peripheral grooves are formed in an inner circumferential surface of the valve housing at a position proximal to the valve portion on an upstream side and/or a downstream side of the valve portion. The peripheral grooves open toward a side opposing to the valve portion in a flow direction.

In a further embodiment, a circumferential wall having a smaller diameter than an inner diameter of the valve housing by a predetermined size extends around an upstream and/or a downstream side surface of the valve seat in a flow direction. Grooves are defined due to a clearance between a circumferential wall of the valve seat and an inner circumferential surface of the valve housing.

In a further embodiment, a corresponding part of the valve housing to the upstream- and/or downstream side of the valve seat in a flow direction may be formed to have an internal/external double layer construction to form grooves to the upstream and/or downstream side of the valve portion in a flow direction.

In a still further embodiment, the grooves are formed to the upstream and/or the downstream side of the valve portion in a flow direction. One of the grooves is formed due to a clearance between the circumferential wall of the valve seat and the inner circumferential surface of the valve housing. The circumferential wall has a smaller diameter than an inner diameter of the valve housing by a predetermined size and extends around the upstream and/or the downstream side surface of the valve seat in a flow direction. The other groove is defined by an internal/external double layer construction of the valve housing.

In a still further embodiment, preferably, a surface of the valve body, at least a part of the surface that contacts the valve seat, may be coated with a hydrophobic material.

In a still further embodiment, the seal may preferably be formed with a plurality of lips.

In a still further embodiment, a part of the bearing portion may preferably be configured to protrude into the flow channel within the valve housing.

### BRIEF DESCRIPTION OF THE DRAWINGS

FIG. 1 is a circuit configuration of a part of a fuel cell mechanism;

FIG. 2 is a schematic cross sectional side view of a fluid control valve device according to a first representative embodiment;

FIG. 3 is an enlarged cross sectional view of a part of the fluid control valve device according to the first representative embodiment;

FIG. 4 is an enlarged cross sectional view of a part of a seal for showing a modification example of the seal according to the first representative embodiment;

FIG. 5 is an enlarged cross sectional view of a part of a seal for showing another modification example of the seal according to the first representative embodiment;

FIG. 6 is an enlarged cross sectional view of a part of a cover for showing a modification example of the cover according to the first representative embodiment;

FIG. 7 is an enlarged cross sectional view of a part according to a second representative embodiment;

FIG. 8 is an enlarged cross sectional view of a part according to a third representative embodiment;

FIG. 9 is an enlarged cross sectional view of a part according to a fourth representative embodiment; and

FIG. 10 is an enlarged cross sectional view of a part according to a fifth representative embodiment.

### DETAILED DESCRIPTION OF THE INVENTION

Each of the additional features and teachings disclosed above and below may be utilized separately or in conjunction with other features and teachings to provide improved fluid control valve devices. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

According to the present invention, a seal is attached around a valve shaft in order to effectively prevent condensed water droplet deposited on a surface of the valve shaft. It is, therefore, possible to avoid an operational failure of a valve. Moreover, because a surface of the valve body, at least a part of the surface that contacts the valve seat, can have hydrophobic properties, such that fluid can be repelled from the surface having hydrophobic properties. Therefore, it is possible to prevent fluid from depositing between the valve shaft and the seal. Further, fluid that moves along the valve shaft from the parts having no hydrophobic properties in a direction toward the bearing portion, can be repelled from the surface with hydrophobic properties. Therefore, it is possible to prevent water from moving further in the direction toward the bearing portion. Force required to remove the seal from the valve shaft when the fluid freezes between the valve shaft and the seat, is proportional to an amount of water deposit and a dimension of the frozen fluid. More specifically, if the amount of the fluid deposited on contact portions of the valve shaft and the seal is small, the dimension of the frozen fluid may also be reduced. Consequently, only a slight force may be required to remove the seal from the valve shaft. Therefore, it is possible effectively to avoid the damage of the seal when the seal is removed from the valve shaft. Because only a slight force is required to remove the seal from the valve shaft, a thrust force of the valve driving source may be reduced. Therefore, it is possible to reduce a cost and a size of the valve device. Further, because the amount of the fluid deposited on the contact portions of the valve shaft and the seal is small, it is possible to reliably prevent fluid from entering the bearing portion.

If fluorine resin is used as a hydrophobic material, a coefficient of sliding friction between the valve shaft and the seal may be reduced. Therefore, it is possible to prevent abrasion of the seal. Because the valve shaft can smoothly slide, a thrust force of the valve driving source may be reduced. Therefore, it is possible to reduce cost and size of the valve device.

Peripheral grooves are defined in the inner circumferential surface of the valve housing at a position proximal to the valve portion on an upstream side and/or a downstream side in a flow direction and open toward a side opposite to the valve portion. Therefore, fluid moving along the inner circumferential surface of the valve housing may be received by the grooves. Thus, because the condensed fluid moving along the inner circumferential surface of the valve housing may be blocked in front of the valve portion, it is possible to reliably prevent the fluid that may move along the inner circumferential surface of the valve housing from depositing on the contact portions of the valve body and the valve seat. If a further groove is defined to the downstream side of the valve portion in a flow direction, the fluid discharged from a discharge channel may be effectively prevented from depositing on the contact portions of the valve body and the valve seat.

If a groove for receiving fluid deposited within the valve housing is defined by adopting a circumferential wall to the valve seat or by forming the valve housing to have an internal/external double layer construction, it is not necessary to provide any additional members to form a groove. Further, it is also possible to reduce cost that may be caused by the increased number of the additional members or the assembly methods.

If a surface of the valve housing, at least a portion that contacts the valve seat, has hydrophobic properties, the fluid moving along the inner circumferential surface of the valve housing may be reliably blocked by the groove. In addition, because a slight amount of fluid that is condensed directly on the valve housing may be repelled from the hydrophobic portions, it is possible to reduce the amount of fluid that deposits on the contact portions of the valve body and the valve seat. Therefore, it is possible effectively to avoid operational failure of the valve.

If the seal is formed with a plurality of lips, a fluid moving along the valve shaft can be more reliably blocked. If a part of the bearing portion is configured to protrude into the flow channel defined within the valve housing, the fluid, which may form on the inner surface of the valve housing, may be prevented from moving toward the entrance of the bearing portion. Therefore, it is possible to reliably prevent the fluid from entering the bearing portion.

Representative embodiments of the present invention will now be described in detail with reference to the attached drawings, however, it is not intended to limit the scope of the invention and the embodiments may be varied in various ways within the scope of the invention. A fluid control valve device of the present invention may be mounted to vehicles, such as automobiles, and may be used for controlling a flow rate of various water (vapor) containing gases such as LPG or exhaust gas, and may be particularly useful for a fuel cell vehicle for controlling a flow rate of gas.

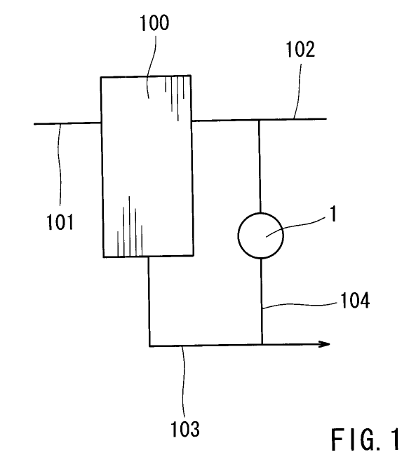

A first representative embodiment of the present invention will now be described with reference to FIGS. 1 to 3.

As shown in FIG. 1, a fuel cell mechanism generally includes a cell stack 100 constructed by a plurality of stacked single cells, in each of which an electrolyte layer is interposed between an anode and a cathode, a fuel gas supply pipe 101 connected to an anode side, an oxidant gas supply pipe 102 connected to a cathode side, a discharge pipe 103 for discharging water generated by an electrochemical reaction or unreacted gas that has passed through the cell stack 100, and a bypass pipe 104 for communicating the oxidant gas supply pipe 102 and the discharge pipe 103. A solid polyelectrolyte membrane made of a polymer ion exchange membrane may be used as multilayer electrodes for the cell stack 100. Hydrogen is supplied via the fuel gas supply pipe 101 as a fuel gas. The hydrogen is supplied from a hydrogen tank or a hydrogen storage alloy tank (not shown) or via a reformer having a fuel combustion part, a reforming pail and a CO reducing part to the cell stack 100 as reformed gas containing hydrogen as a main component and generated by methanol and oxygen. Air is supplied from the oxidant gas supply pipe 102 as oxidant gas. The air is externally introduced and is supplied by an air compressor (not shown). The bypass pipe 104 is constructed for controlling a flow rate (gas pressure) of hydrogen gas and air in order to achieve an efficient reaction of the fuel cell by removing a difference in pressure between the hydrogen gas and the air in the cell stack 100. A fluid control valve device 1 is disposed on the way of the bypass pipe 104. Therefore, the fluid to be controlled by the valve device 1 of the first representative embodiment is air.

When a valve of the fluid control valve device 1 is closed, the entire air passing through the oxidant gas supply pipe 102 is supplied to the cell stack 100. On the other hand, when the valve of the fluid control valve device 1 is opened, a part of the air passing through the oxidant gas supply pipe 102 is directly discharged into the discharge pipe 103 via the bypass pipe 104. Therefore, an amount of the air supplied to the cell stack 100 may be reduced. For example, an amount of the hydrogen gas supply is not sufficient directly after starting a vehicle, particularly at low temperature. In this case, the supply rates of the hydrogen gas and the air to the stack 100 may become out of balance. As a result, a power generating efficiency may be reduced due to an unbalanced mixing ratio of the hydrogen and the oxygen. It may also cause a damage of the solid polyelectrolyte membrane due to the difference in pressure. These problems may be avoided if the air supply rate from the oxidant gas supply pipe 102 is controlled by opening the valve of the fluid control valve device 1 for a predetermined period of time (about 30 seconds) after starting the vehicle. The valve is controlled by a control means (not shown) to open or close. The hydrogen supplied from the fuel gas supply pipe 101 and the oxygen in air supplied from the oxidant supply pipe 102 are electrochemically reacted via the solid polyelectrolyte membrane within the cell stack 100 so that electricity as well as water are generated. The generated water may be discharged out of the vehicle via the discharge pipe 103. Further, the hydrogen supplied from the fuel gas supply pipe 101 is not entirely used for anode of the cell stack 100. Only 80% of the hydrogen may be used and the unused (unreacted) hydrogen gas is discharged out of the system via the discharge pipe 103. Further, because the air supplied from the oxidant gas supply pipe 102 is also supplied more than the amount of the oxygen required for the cathode of the cell stack 100, the entire amount of the air may not be used. Therefore, the unused air or the unreacted air containing, for example, nitrogen, which is not directly involved in the electrochemical reaction of the fuel cell, may also be discharged via the discharge pipe 103 out of the system.

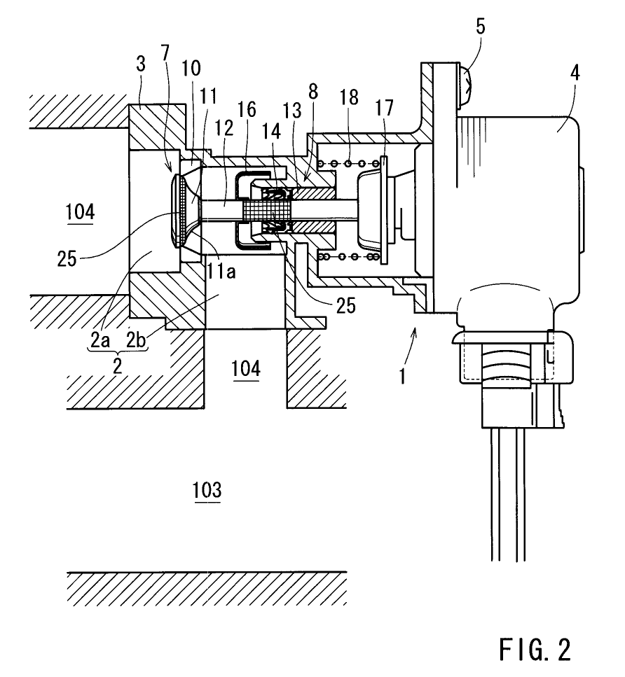

Further, a general construction of the fluid control valve device 1 will be described. FIG. 2 shows the fluid control valve device 1 when the valve is closed. As shown in FIG. 2, the fluid control valve device 1 has a valve housing 3, and an actuator 4 as a power source. The valve housing 3 is made of aluminum alloy and has a flow channel 2 formed therethrough for the air flow. The actuator 4 is fixed to the valve housing 3 by means of a screw 5. A valve portion 7 is provided on the way of the flow channel 2 and is constructed with a valve seat 10 and a valve body 11, which reciprocally moves toward/away from the valve seat 10 in an axial direction. The flow channel 2 is formed within the valve housing 3 to have a cylindrical configuration and is separated to an upstream flow channel 2a and a downstream flow channel 2b by the valve portion 7. The upstream flow channel 2a is communicated with the oxidant gas supply pipe 102 via the bypass pipe 104 and the downstream flow channel 2b is communicated with the discharge pipe 103 via the bypass pipe 104. The valve body 11 is crimped to be fixed on tip end of a valve shaft 12 connected to the actuator 4. The valve portion 7 is closed when the valve body 11 contacts the valve seat 10. The valve seat 10 is made of a stainless ring member having a predetermined thickness in a radial direction and is press-fitted to an inner circumferential surface of the valve housing 3. The valve body 11 is a substantially conical member made of stainless and has a throttle surface 11a on the downstream side in a flow direction that contacts the valve seat 10 when the valve is closed. The valve shaft 12 is also made of stainless having a cylindrical configuration.

The valve housing 3 is provided with a bearing portion 8 for supporting the valve shaft 12. A cylindrical bearing 13 made of a copper sintered body and a resilient seal body 14 attached around the valve shaft 12 on a front side (valve body 11 side) of the bearing 13, is accommodated within the bearing portion 8. A cover 16 is disposed on the front side of the bearing portion 8. A spring holder 17 is fitted to a rear end (actuator 4 side) of the valve shaft 12. The valve body 11 is always biased in a closed direction of the valve by means of a return spring 18, which is interposed between the spring holder 17 and the valve housing 3. The valve body 11 and the valve shaft 12 slidably move in an axial direction when the actuator 4 is driven. The valve body 11 located in a closed position is pressed via the valve shaft 12 due to a biasing force of the return spring 18 when the actuator is driven 14. The valve body 11 then moves away from the valve seat 10 against the biasing force of the return spring 18 to open the valve portion 7.

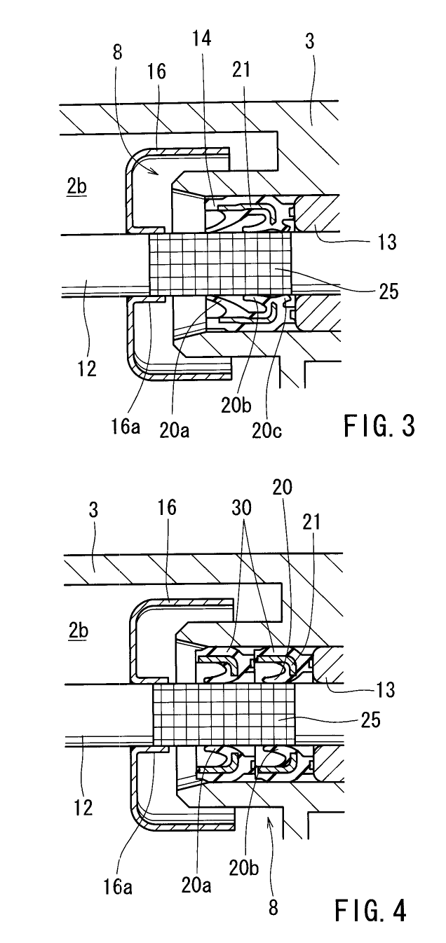

According to FIG. 3, a part of the front side (valve body 11 side) of the bearing portion 8 protrudes with a predetermined dimension into the flow channel 2 within the valve housing 3. The cover 16 has a insertion hole centrally of one end surface and the other end surface of the cover 16 is opened to have a cylindrical configuration with a diameter larger than the bearing portion 8. The valve shaft 12 is press-fitted into the insertion hole formed centrally one end surface of the cover 16 so that the cover 16 moves together with the valve shaft 12. The open side of other end surface of the cover 16 covers an outside of the front end portion of the bearing portion 8, which protrudes into the flow channel 2. The seal body 14 is a rubber molded element formed substantially into a ring shape. An inner circumferential surface of the seal body 14 is integrally formed with three lips 20 aligned in the axial direction of the valve shaft 12. Each lip 20 closely contacts the valve shaft 12 to form a triple seal construction. Oil is filled between each lip 20 in order to improve a sealing property. A ring 21 made of HNBR for maintaining shape is arranged within the seal body 14 by insert molding.

The fluid control valve 1 of the first representative embodiment is configured to control air flow rate. Therefore, if the fluid control valve 1 is used under a low temperature, for example, in winter or in a cold region, the water vapor in the air may be condensed within the valve housing 3 and the condensed fluid may form on the surface of the valve shaft 12. In this case, when the valve body 11 is moved away from the valve seat 10 to open the valve portion 7, the air streams from the upstream flow channel 2a toward the bearing portion 8 generating an air pressure. Due to the air pressure, the water deposited on the surface of the valve shaft 12 may attempt to enter a side of bearing 13. However, it is possible to prevent the air pressure from being directly applied to the bearing portion 8 since the cover 16 is fixed on the front side of the bearing portion 8. It is also possible to prevent water from entering the fixing portion 16a of the cover 16 to a certain extent. The fluid condensed between the cover 16 and the bearing portion 8 may move in a direction toward the bearing 13 in accordance with a reciprocal sliding movement of the valve shaft 12. The seal body 14 is provided in order to prevent the movement of the condensed fluid in a direction toward the bearing 13. The seal body 14 is formed with three lips 20 including a first lip 20a, a second lip 20b and a third lip 20c. The first lip 20a disposed on the front side is formed as a subseal and serves to prevent a majority of the fluid from entering. The second and the third lips 20b and 20c are formed as main seals and serve to ensure that the rest of the water may not enter. The seal body 14 also prevents the air from entering from a clearance between the cover 16 and the bearing portion 8 to flow into the bearing 13. If the water vapor is condensed on a part of the inner circumferential surface of the valve housing 3 within the region of to the downstream flow channel 2b, the fluid trickle down along the inner circumferential surface of the valve housing 3 and may enter the bearing portion 8. Therefore, because the front end portion of the bearing portion 8 protrudes into the flow channel 2, the fluid entered by trickling down along the inner circumferential surface of the valve housing 3 may be collected outside of the bearing portion 8. As a result, the water collected outside of the bearing portion 8 may be discharged into the discharge pipe 103 along the outer circumferential surface of the bearing portion 8 before the water reaches the entrance of the bearing portion 8. In other words, because the front end portion of the valve portion 8 protrudes into the flow channel 2, a substantial groove is defined between the bearing portion 8 and the inner circumferential surface of the valve housing 3. With this construction, it is possible to avoid the operational failure due to the frozen fluid between the valve shaft 12 and the bearing 13.

However, the fluid blocked by the seal body 14 may freeze between the seal body 14 and the valve shaft 12. In this case, if the valve shaft 12 is forced to remove from the seal body 14 against the adhesion force of the ice, the resilient seal body 14 may be damaged. The surface of the valve shaft 12 according to the first representative embodiment is coated with a hydrophobic material. The hydrophobic material may be coated on a surface of the valve shaft 12 where the valve shaft 12 slidably contacts the seal body 14 when the valve shaft 12 reciprocally moves in an axial direction, however, the area to be coated is not limited to this. In the first representative embodiment, the hydrophobic material is coated within the area between the position adjacent to the rear side of the third rear lip 20c and the fixing portion 16a of the cover 16 (screened area in FIGS. 2 and 3). As a result, it is possible to reduce the amount of water deposited between the valve shaft 12 and the seal body 14, and the frozen area of ice because a hydrophobically coated surface 25 may repel water. Consequently, the damage risk of the seal body 14 may be significantly reduced. In addition, since the hydrophobically coated surface 25 extends to the fixing portion 16a of the cover 16, the fluid entering from an insertion hole of the cover 16 may be repelled.

The following materials may be used as hydrophobic coating and may be coated in a known method:

Fluorine resins such as PTFE, PVDF and PFA; diene polymers/copolymers such as polypropylene, polybutadiene, polyisoprene and ethylene-butadiene copolymer; synthetic rubbers such as styrene-butadiene copolymer, methyl methacrylate-butadiene copolymer and acrylonitrile-butadiene copolymer; acrylic acid esters such as polymethylmethacrylate, methyl methacrylate-(2-ethylhexylacrylate) copolymer, methylmethacrylate-methacrylate copolymer, methylacrylate-(N-methylolacrylamide) copolymer, and polyacrylonitrile copolymer; vinyl ester polymers/copolymers such as acrylic acid polymer/copolymer, polyvinyl acetate, vinyl acetate-vinyl Propionate copolymer, vinyl acetate-ethylene copolymer; and hydrophobic resins such as vinyl acetate-(2-ethylhexyl acrylate) copolymer, polyvinylchloride, polyvinylidene chloride, polystyrene, phenol resin, urea resin, ketonic resin, rosin resin, butyral resin and polyamide resin. Preferably, a fluorine resin may be used because the sliding friction with the seal body 14 can be reduced due to a low frictional coefficient of the fluorine resin. In the first representative embodiment, TEFLON® is used as a coating material.

A hydrophobic material also may be coated around a throttle surface 11a of the valve body 11 in part, where the valve seat 10 contacts when the valve is closed as shown in FIG. 2. TEFLON® is used also in this case as a coating material. Therefore, the fluid is repelled from the hydrophobically coated surface 25 so that the amount of the fluid deposited between the valve seat 10 and the valve body 11 may be reduced and the operational failure can be avoided.

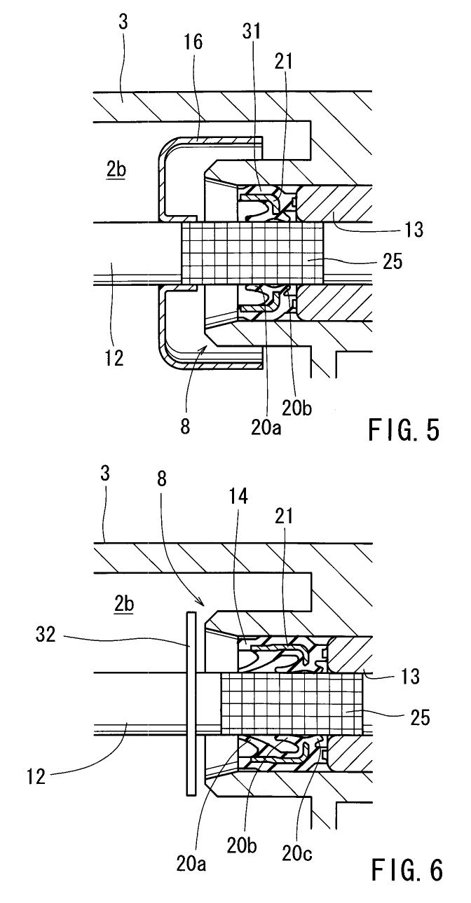

In the first representative embodiment, three lips 20a, 20b and 20c are integrally formed with a single seal body 14. However, the number of the lips is not limited to three, but may be two. For example, as shown in FIG. 4, only a single lip 20 may be formed with each one of seal bodies 30 and a pair of seal bodies 30 may be aligned in an axial direction of the valve shaft 12. Further, as shown in FIG. 5, a pair of lips 20a and 20b may be integrally formed with a single seal body 31. In all cases, the functions of the front lip 20a as a subseal and the rear lip 20b as a main seal remain the same as the function described in the first representative embodiment. Also, oil may be filled between the front and the rear lips 20a and 20b as described in the first representative embodiment. Further, the number of the lips 20 may be only one, or may be four.

According to the first representative embodiment, the cylindrical cover 16 is disposed in front of the bearing portion 8. However, a flat disk plate 32 may be used as shown in FIG. 6 instead of the cylindrical cover 16. In this way, it is also possible to prevent the air pressure from being directly applied to the bearing portion 8 and to prevent the fluid from entering the bearing portion 8 moving along the valve shaft 12 from its tip end side.

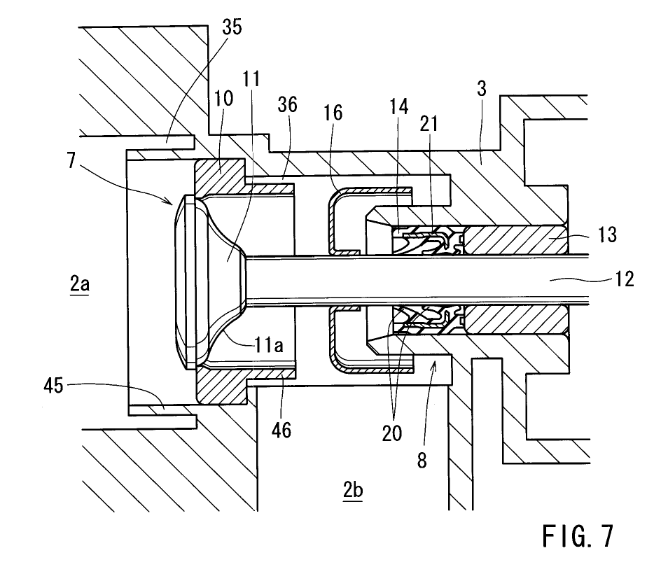

A second representative embodiment of the fluid control valve device 1 according to the present invention will be described with reference to the FIG. 7. The fluid control valve device 1 according to the second representative embodiment provides a different construction from that of the first representative embodiment in order to prevent fluid from depositing on the valve portion 7. Reference numerals that same as in the first embodiment have substantially the same construction, therefore a detailed explanation of those reference numerals is omitted. FIG. 7 shows peripheral grooves 35 and 36 defined in the inner circumferential surface of the valve housing 3 at a position proximal to the valve portion 7 on an upstream side and/or a downstream side in a flow direction, respectively. More specifically, a circumferential wall 45 having a smaller diameter than an inner diameter of the valve housing 3 by a predetermined size is formed integrally with the valve housing 3 and extends from a position of the valve portion 7 disposed within the inner circumferential surface of the valve housing 3 toward the upstream flow direction to form an internal/external double layer construction. The upstream groove 35 is formed due to the clearance defined between the circumferential wall 45 and the inner circumferential surface of the valve housing 3. The upstream groove 35 opens toward the upstream side (a side opposite to the valve portion 7) in the flow direction. Further, a circumferential wall 46 having a smaller diameter than an inner diameter of the valve housing 3 by a predetermined size extends integrally from the downstream side surface of the valve seat 10 toward the downstream flow direction. More particularly, the circumferential wall 46 extends from the inner circumferential edge of the valve seat. The down stream groove 36 is formed due to the clearance defined between the circumferential wall 46 of the valve seat 10 and the inner circumferential surface of the valve housing 3. The downstream groove 36 opens toward the downstream flow direction (a side opposite to the valve portion 7). The inner diameter of the circumferential wall 45 of the valve housing 3 is configured to have a substantially same size as the outer diameter of the valve seat 10.

Fluid vapor contained in the air supplied from the oxidant gas supply pipe 102 may be condensed on the inner circumferential surface of the valve housing 3 in the area corresponding to the upstream flow channel 2a. Even if the condensed droplets flow in a direction to valve portion 7 due to the blowing pressure of the air, the fluid may not deposit on the contacting portions of the valve seat 10 and the valve body 11 because the fluid is kept in the upstream groove 35 in the above construction. Further, unreacted air may reversely flow from the discharge pipe 103 into the downstream flow channel 2b within the valve housing 3, when the valve 7 is closed. In this case, the vapor may be condensed on the inner circumferential surface of the valve housing 3 in the area corresponding to the downstream flow channel 2b. Even if the condensed fluid flows in a direction to valve portion 7 due to the blowing pressure of the air, the fluid may not deposit on the contacting portions of the valve seat 10 and the valve body 11 because the fluid is kept in the downstream groove 36. The fluid condensed on the inner circumferential surface of the valve housing 3 corresponding to the upstream/downstream side of the valve portion 7 can be reliably blocked by the upstream groove 35 and the downstream groove 36. With this configuration, the valve seat 10 is less likely to be adhered to the valve body 11, therefore it is possible to reduce or prevent future operational failure.

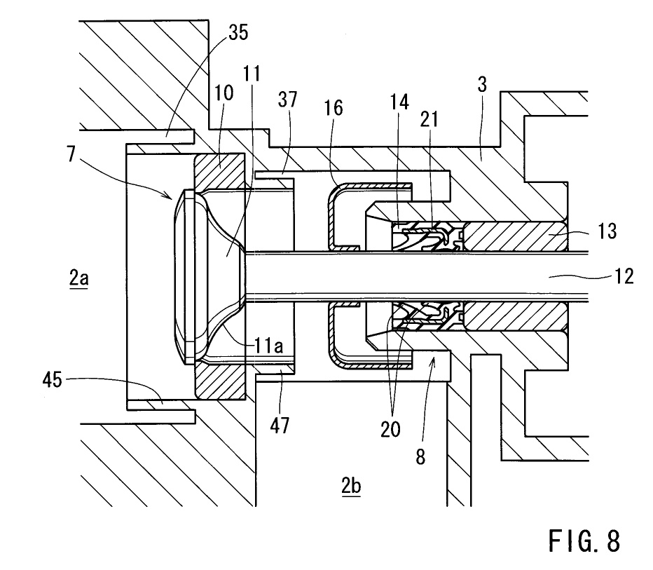

A third representative embodiment of the fluid control valve device 1 according to the present invention will be described with reference to FIG. 8. The third representative embodiment describes a modification of the grooves 35 and 36 according to the second representative embodiment. Reference numerals that same as in the second embodiment have substantially the same construction, therefore a detailed explanation of those reference numerals is omitted. As shown in FIG. 8, a downstream groove 37 on the downstream side of the valve portion 7 is formed by an internal/external double layer construction of the valve housing 3 in the same manner as the upstream groove 35 instead of adopting the circumferential wall 46 of the valve seat 10 as described in the second representative embodiment. More specifically, a circumferential wall 47 having a smaller diameter than an inner diameter of the valve housing 3, extends integrally from the inner circumferential surface of the valve housing 3 corresponding to a downstream end position of the valve seat 10 toward the downstream flow direction to form an internal/external double layer construction. The downstream groove 37 opens toward the downstream side (a side opposite to the valve portion 7) in the flow direction. Therefore, similar to the second representative embodiment already described, although the water vapor contained in the unreacted air, which is reversely entered from the discharge pipe 103, may be condensed in the area corresponding to the downstream flow channel 2b within the valve housing 3 when the valve portion 7 is closed, the fluid are substantially confined in the downstream groove 37 and therefore do not adhere onto contacting portions of the valve seat 10 and the valve body 11.

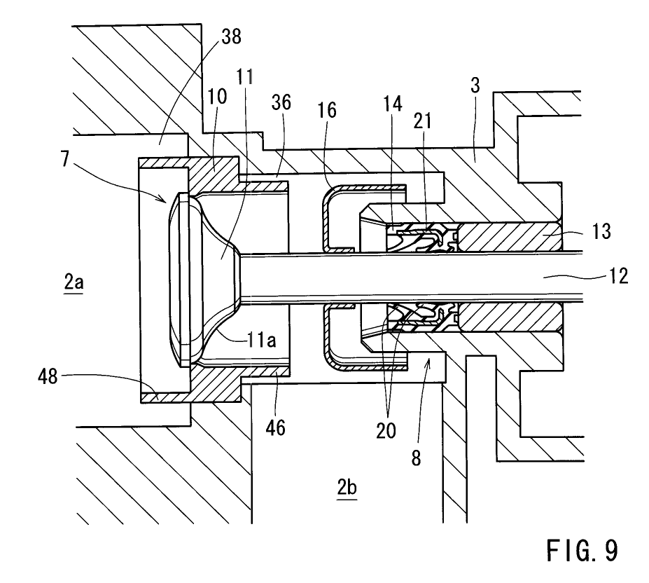

A fourth representative embodiment of the fluid control valve device 1 according to the present invention will be described with reference to FIG. 9. The fourth representative embodiment is also a modification of the grooves 35 and 36 according to the second representative embodiment. Reference numerals that same as in the second embodiment have substantially the same construction, therefore a detailed explanation of those reference numerals is omitted. As shown in FIG. 9, a circumferential wall 48 is defined on the upstream side surface of the valve seat 10 to form an upstream groove 38 positioned on the upstream side of the valve portion 7 in the flow direction instead of adopting the circumferential wall 45 of the valve housing 3 of the second embodiment. More specifically, the circumferential wall 48 has a smaller diameter than an inner diameter of the valve housing 3 by a predetermined size and, extends integrally from the outer circumferential edge of the upstream side surface of the valve seat 10 towards upstream flow direction. The upstream groove 38 is formed due to the clearance between the circumferential wall 48 of the valve seat and the inner circumferential surface of the valve housing 3. The upstream groove 38 opens toward the downstream side (a side opposite to the valve portion 7) in the flow direction. Therefore, similar to the second representative embodiment already described, although the fluid vapor contained in the air (which is supplied from the oxidant gas supply pipe 102) can be condensed onto the inner circumferential surface of the valve housing 3 in the area corresponding to the upstream flow channel 2a, the fluid can be substantially confined in the upstream groove 38 and therefore does not adhere onto contacting portions of the valve seat 10 and the valve body 11.

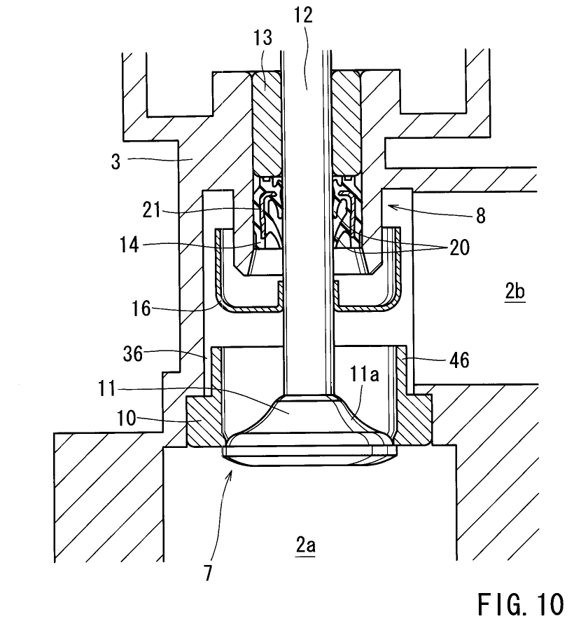

In each embodiment as described above, the fluid control valve device 1 is arranged so that the valve shaft 12 can slidably move in a horizontal direction. However, the fluid control valve device 1 may also be arranged so that the valve shaft 12 can slidably move in a vertical direction. FIG. 10 shows the fluid control valve device 1 of the present invention according to a fifth embodiment. As shown in FIG. 10, the valve portion 7 of the fluid control valve device 1 is disposed in a position lower than the position of the bearing portion 8 so that the valve shaft 12 extends in a vertical direction. In this case, the fluid condensed in the area corresponding to the upstream flow channel 2a may drop downwardly opposite to the valve portion 7 due to gravity. Therefore, the downstream groove may be omitted, however, more preferably, the groove may be maintained.

In another modification, the valve shaft 12 is vertically arranged so that the valve portion 7 is positioned higher than the position of the bearing portion 8 opposite to the arrangement of the fifth embodiment. Further, the fluid control valve device 1 may be arranged so that the valve shaft 12 may incline upward or downward. The downstream groove may be omitted also in this case.

The second to fifth representative embodiments show the upstream or downstream grooves that are formed in positions adjacent to the upstream side surface or the downstream side surface of the valve seat 10. However, the grooves may be formed in positions slightly displaced from the positions adjacent to the upstream side surface and/or the downstream side surface of the valve seat 10 if the grooves are still in positions close to the upstream side surface and/or the downstream side surface of the valve portion 7 so that the fluid can be prevented from entering the valve portion 7.

A groove is not formed on the inner circumferential surface of the valve housing 3 according to the first representative embodiment, however, preferably, the grooves according to the second to the fifth representative embodiments may be formed. In the same way, the valve body 11 and the valve shaft 12 according to the second to the fifth representative embodiments are not coated with a hydrophobic material, however, the surface of the valve body 11 and the valve shaft 12 may also be coated with the hydrophobic material as described in the first representative embodiment.

The entire surface of each of the valve body 11 and the valve shaft 12 may be coated with the hydrophobic material.

This invention claims:

1. A fluid control valve device comprising:
a valve portion; and
a bearing portion; and
wherein the valve portion is constructed with a valve seat arranged within a valve housing and a valve body capable of reciprocally moving towards and away from the valve seat in an axial direction;
wherein the bearing portion is configured to accommodate a bearing and a seal;
wherein the bearing portion supports a valve shaft coupled to the valve body;
wherein the seal is attached around the valve shaft in order to prevent fluid from entering the bearing portion; and
wherein at least a part of a surface of the valve shaft that slidably contacts with the seal, has a hydrophobic property.

2. The fluid control valve device as in claim 1, wherein the part having the hydrophobic property comprises a fluorine resin coating.

3. A fluid control valve device comprising:
a valve portion; and
a bearing portion; and
wherein the valve portion is constructed with a valve seat arranged within a valve housing and a valve body is capable of reciprocally moving towards and away from the valve seat in an axial direction;
wherein the bearing portion is configured to accommodate a bearing and a seal;
wherein the bearing portion supports a valve shaft coupled to the valve body;
wherein the seal is attached around the valve shaft in order to prevent fluid from entering the bearing portion;
wherein a peripheral groove is formed in an inner circumferential surface of the valve housing at a position proximal to the valve portion on at least one of the upstream and downstream side; and
wherein the groove opens toward a side opposite to the valve portion in a flow direction of the fluid.

4. The fluid control valve device as in claim 3, wherein a circumferential wall having a smaller diameter than an inner diameter of the valve housing by a predetermined size extends from at least one of an upstream side surface and a downstream side surface of the valve seat in the flow direction; and
wherein the groove is defined by a clearance between the circumferential wall of the valve seat and the inner circumferential surface of the valve housing.

5. The fluid control valve device as in claim 3, wherein a part of the valve housing proximal to the valve portion on at least one of the upstream and downstream side in the flow direction has an internal/external double layer construction to form the groove on the at least one of the upstream side and downstream side of the valve portion in the flow direction.

6. The fluid control valve device as in claim 3, wherein the grooves are formed proximate to valve portion on the upstream and the downstream side of the valve portion in the flow direction;
wherein one of the grooves is defined by a clearance between a circumferential wall of the valve seat and the inner circumferential surface of the valve housing;
wherein the circumferential wall has a smaller diameter than an inner diameter of the valve housing by a predetermined size and extends from at least one of an upstream side surface and a downstream side surface of the valve seat in the flow direction; and
wherein the other groove is defined by an internal/external double layer construction of the valve housing.

7. The fluid control valve device as in claim 1, wherein at least a part of a surface of the valve body that contacts the valve seat has the hydrophobic property.

8. The fluid control valve device as in claim 1, wherein the seal is formed with a plurality of lips.

9. The fluid control valve device as in claim 1, wherein a part of the bearing portion protrudes into a flow channel defined within the valve housing.

10. The fluid control valve device as in claim 3, wherein at least a part of a surface of the valve body that contacts the valve seat has the hydrophobic property.

11. The fluid control valve device as in claim 3, wherein the seal is formed with a plurality of lips.

12. The fluid control valve device as in claim 3, wherein a part of the bearing portion protrudes into a flow channel defined within the valve housing.
